(19) United States
(12) Patent Application Publication
(10) Pub. No.: US 2018/0307743 A1
(43) Pub. Date: Oct. 25, 2018

(54) MAPPING METHOD AND DEVICE

(71) Applicant: ALIBABA GROUP HOLDING LIMITED, George Town (KY)

(72) Inventors: Xu CHEN, Hangzhou (CN); Jin YU, Hangzhou (CN); Xiaolong LI, Hangzhou (CN); Yi DING, Hangzhou (CN); Huaidong XIONG, Hangzhou (CN)

(73) Assignee: ALIBABA GROUP HOLDING LIMITED

(21) Appl. No.: 16/024,585

(22) Filed: Jun. 29, 2018

Related U.S. Application Data
(63) Continuation of application No. PCT/CN2016/112855, filed on Dec. 29, 2016.

(30) Foreign Application Priority Data
Jan. 7, 2016 (CN) 201610009341.4

(51) Int. Cl. G06F 17/30; G06N 99/00

(52) U.S. Cl. CPC G06F 17/30598; G06N 99/005; G06F 17/30958; G06F 17/3033

(57) ABSTRACT

Embodiments of the disclosure provide a mapping method for a primary server in a cluster system, a mapping method for a sub-server in a cluster system, the primary server, and the sub-sever. The mapping method for a mapping method for a primary server in a cluster system further including sub-servers can include: segmenting an input discrete set into a plurality of discrete subsets that includes a first discrete subset and a second discrete subset; distributing the plurality of discrete subsets into the sub-servers; acquiring first and second mapping consecutive integer subsets from first and second sub-servers; and obtaining a mapping consecutive integer set based on the first and second mapping consecutive integer subsets.

### CROSS REFERENCE TO RELATED APPLICATION

The disclosure claims the benefits of priority to International Application Number PCT/CN2016/112855, filed Dec. 29, 2016, which claims priority to Chinese Application Number 201610009341.4, filed Jan. 7, 2016, both of which are incorporated herein by reference in their entireties.

### BACKGROUND

With the continuous development of network technologies, the amount of data generated in the field of the Internet has grown explosively. A large amount of data information of great significance is randomly distributed in massive-scale Internet data. Data information required by industries are usually processed and mined by using a machine learning algorithm. For example, in systems for massive data processing (e.g., ranking based on search results, prediction of Internet advertisement click-through rate, personalized item recommendation, voice recognition, and intelligent question-answer), a super-large-scale machine learning algorithm has become one of the most important technical supports.

In a machine learning algorithm, operations are generally performed on continuous numerical matrixes and vectors, and this requires input data to be a continuous numerical space. However, the large-scale data in the field of the Internet is generally summarized from click logs, search query logs, or item purchase logs of users. In other words, most Internet data exists in a form of discrete sets. For example, the discrete sets can include:

a set of user IDs: {user_1, user_2, . . . , user_n};

a set of item IDs: {item_1, item_2, . . . , item_n};

a set of search queries: {“men's wear”, “high-heeled shoes”, . . . }.

Therefore, before the machine learning algorithm is executed, a discrete set can be converted into a continuous numerical space usable in the machine learning algorithm by using a continuous numeralization method. In other words, a discrete set can be mapped to a consecutive integer set, as below:

f:S→N,

wherein S is an original discrete set, N is a natural number set after mapping and is in a range of

[0,n−1],n=|S|.

The original discrete set can be mapped to a consecutive integer set by using the foregoing mapping relationship. Thus, conversion from a sample matrix to a numerical matrix can be completed. Then, the numerical matrix is input to the machine learning algorithm to complete a subsequent calculation process.

A hash table mapping approach is generally employed in the continuous numeralization method in the prior art. For example, a hash table can be constructed to determine whether each element input to the set has a corresponding entry in the hash table by querying the hash table. Next, different execution manners can be selected according to determination results. If an entry corresponding to the element exists in the hash table, the element can be ignored. If an entry corresponding to the element does not exist in the hash table, an integer value can be assigned to the element. The integer value is equivalent to the total number of elements in the current hash table, and the element and the assigned corresponding integer value can be added to the hash table. A finally formed hash table is the mapping relationship. The original input set can be converted into an integer value set according to the mapping relationship.

The conventional hash table mapping have at least has the following problems:

(1) Globally unique integer values can be obtained only by storing elements in the whole original discrete set into the same hash table. However, the amount of data that can be stored in a single hash table is limited by hardware conditions, and concurrent read/write operations cannot be performed. Therefore, hardware may fail to meet a processing requirement.

(2) Data cannot be processed concurrently through cluster resources by using multiple processes, resulting in low processing efficiency. This is not suitable for processing of current large-scale data sets over the Internet.

(3) Content of the original discrete set should be saved in the hash table as mapping keys. Then, if the original discrete set occupies large memory space, the mapping keys will also occupy large memory space correspondingly. Meanwhile, all mapping pairs may be loaded on a single computer. Thus, an upper limit of the scale of the original discrete set processed by the system can be restricted by an upper limit of a memory of a single computer, and linear scaling cannot be implemented.

The foregoing disadvantages may restrict the scale of data and features required by machine learning at different levels, thus affecting a final effect that can be achieved by the machine learning algorithm.

Therefore, continuous numeralization for a super-large-scale discrete may be restricted by a memory of a single computer and computing resources, and the input set cannot be linearly scaled correspondingly, thus affecting mapping conversion efficiency and a learning effect of the machine learning algorithm, and also wasting a large quantity of hardware resources.

### SUMMARY OF THE DISCLOSURE

In view of the problems, the present application provides a mapping method for optimizing a mapping algorithm and segments and concurrently processing a discrete set, so that the problem of restrictions caused by a memory of a single computer and computing resources can be solved. The input discrete set can be linearly scaled correspondingly, thus saving hardware resources and also improving mapping conversion efficiency as well as a learning effect of a machine learning algorithm.

Embodiments of the disclosure provide a mapping method for a primary server in a cluster system, wherein the cluster system further includes a plurality of sub-servers. The method can include: segmenting an input discrete set into a plurality of discrete subsets that includes a first discrete subset and a second discrete subset; distributing the plurality of discrete subsets into the sub-servers, wherein a first sub-server of the plurality of sub-servers obtains a first offset value and a first consecutive integer subset corresponding to a first discrete subset distributed to the first sub-server and adds values of elements in the first consecutive integer subset with the first offset value to obtain a first mapping consecutive integer subset corresponding to the first discrete subset, and a second sub-server of the plurality of sub-servers obtains a second offset value and a second consecutive integer subset corresponding to the second discrete subset distributed to the second sub-server and adds values of elements in the second consecutive integer subset with the second offset value to obtain a second mapping consecutive integer subset corresponding to second discrete subset; acquiring the first and second mapping consecutive integer subsets from the first and second sub-servers; and obtaining a mapping consecutive integer set based on the first and second mapping consecutive integer subsets.

In some embodiments, segmenting the input discrete set into the plurality of discrete subsets further includes: obtaining hash values for elements in the discrete set through mapping according to a hash function; performing a modulo operation on the hash values with respect to a positive integer, to obtain a mod value corresponding to the hash values; and classifying elements having equal mod values into a discrete subset to form at least one discrete subset of the plurality of discrete subsets.

In some embodiments, obtaining the mapping consecutive integer set based on the first and second mapping consecutive integer subsets further includes: determining a union of the first and second mapping consecutive integer subsets; and ranking elements in the union by magnitude to obtain the mapping consecutive integer set.

Embodiments of the disclosure further provide a mapping method for a sub-server in a cluster system, wherein the cluster system further includes a primary server. The method can include: receiving a discrete subset from the primary server; obtaining an offset value and a consecutive integer subset corresponding to the discrete subset; adding values of the elements in the consecutive integer subset with the offset value to obtain a mapping consecutive integer subset corresponding to the discrete subset; and transmitting the mapping consecutive integer subset to the primary server for generating a mapping consecutive integer set based on the mapping consecutive integer subset.

In some embodiments, obtaining the offset value and the consecutive integer subset corresponding to the discrete subset further includes: determining whether the discrete subset is ranked in a first place among discrete subsets; in response to the discrete subset being ranked in a first place among discrete subsets, setting the offset value corresponding to the discrete subset to 0; and in response to the discrete subset being not ranked in a first place among discrete subsets, setting the offset value corresponding to the discrete subset to a total number of elements in the discrete subsets ranked in front of the discrete subset.

In some embodiments, obtaining the offset value and the consecutive integer subset corresponding to the discrete subset further includes: constructing hash functions having reference numbers, a number of the hash functions corresponding to the total number of elements in the discrete subset, wherein the reference numbers of the hash functions form a numeric sequence of consecutive integers starting from 0; determining the reference numbers of the hash functions corresponding to the elements, and determining the hash values corresponding to the elements; and sorting the hash values to obtain the consecutive integer subset corresponding to the discrete subset.

In some embodiments, determining the reference numbers of the hash function corresponding to the elements further includes: determining a number of hash values corresponding to the discrete subsets according to mapping results of the elements based on the hash functions; constructing an acyclic hypergraph by using a number of the elements as an edge quantity and the number of the hash values as a node quantity; traversing edges of the acyclic hypergraph to generate an array; and determining the reference numbers of the hash functions corresponding to elements based on the array and a reference number determination formula.

In some embodiments, determining the numbers of the hash functions corresponding to the element based on the array and the reference number determination formula further includes: determining a reference number value corresponding to the element according to the array and the reference number determination formula; determining whether the reference number value has been occupied; and in response to the reference number value having not been occupied, setting the reference number value as the reference number of the hash function corresponding to the element.

In some embodiments, sorting the hash values to obtain the consecutive integer subset corresponding to the discrete subset further includes: determining, according to the reference number of the hash function, a number of reference numbers that have been assigned before assignment of the reference number, an integer corresponding to the hash value being a value of the number; and summarizing integers corresponding to the hash values to obtain the consecutive integer subset corresponding to the discrete subset.

Embodiments of the disclosure also provide a primary server in a cluster system, wherein the cluster system further includes a plurality of sub-servers. The primary server can further include: a segmentation module configured to segment an input discrete set into a plurality of discrete subsets; a distribution module configured to distribute the plurality of discrete subsets into sub-servers, wherein a first sub-server of the plurality of sub-servers obtains a first offset value and a first consecutive integer subset corresponding to a first discrete subset distributed to the first sub-sever, and adds values of elements in the first consecutive integer subset with the first offset value to obtain a first mapping consecutive integer subset corresponding to the first discrete subset, and a second sub-server of the plurality of sub-servers obtains a second offset value and a second consecutive integer subset corresponding to a second discrete subset distributed to the second sub-server and adds values of elements in the second consecutive integer subset with the second offset value to obtain a second mapping consecutive integer subset corresponding to the second discrete subset; a first processing module configured to acquire the first and second mapping consecutive integer subsets from the first and second sub-servers, and obtain a mapping consecutive integer set based on the first and second mapping consecutive integer subsets.

Embodiments of the disclosure also provide a sub-server in a cluster system, wherein the cluster system further includes a primary server, and the sub-sever further includes: a receiving module configured to receive a discrete subset from the primary server; a second processing module configured to obtain an offset value and a consecutive integer subset corresponding to the discrete subset, and add values of the elements in the consecutive integer subset with the offset value to obtain a mapping consecutive integer subset corresponding to the discrete subset; and a forwarding module configured to transmit the mapping consecutive integer subset to the primary server for generating a mapping consecutive integer set based on the mapping consecutive integer subset.

### BRIEF DESCRIPTION OF THE DRAWINGS

The accompanying drawings described here are used to provide further understanding of the present disclosure and constitute a part of the present disclosure. The exemplary embodiments of the present disclosure and the description of embodiments are used to illustrate the present disclosure, but do not constitute any improper limitation to the present disclosure.

FIG. 1 is a schematic flowchart of an exemplary mapping method according to embodiments of the present application.

FIG. 2 is a schematic flowchart of an exemplary mapping method according to embodiments of the present application.

FIG. 3 is a schematic flowchart of an exemplary mapping method according to embodiments of the present application.

FIG. 4 is a schematic structural diagram of an exemplary server according to embodiments of the present application.

FIG. 5 is a schematic structural diagram of an exemplary server according to embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

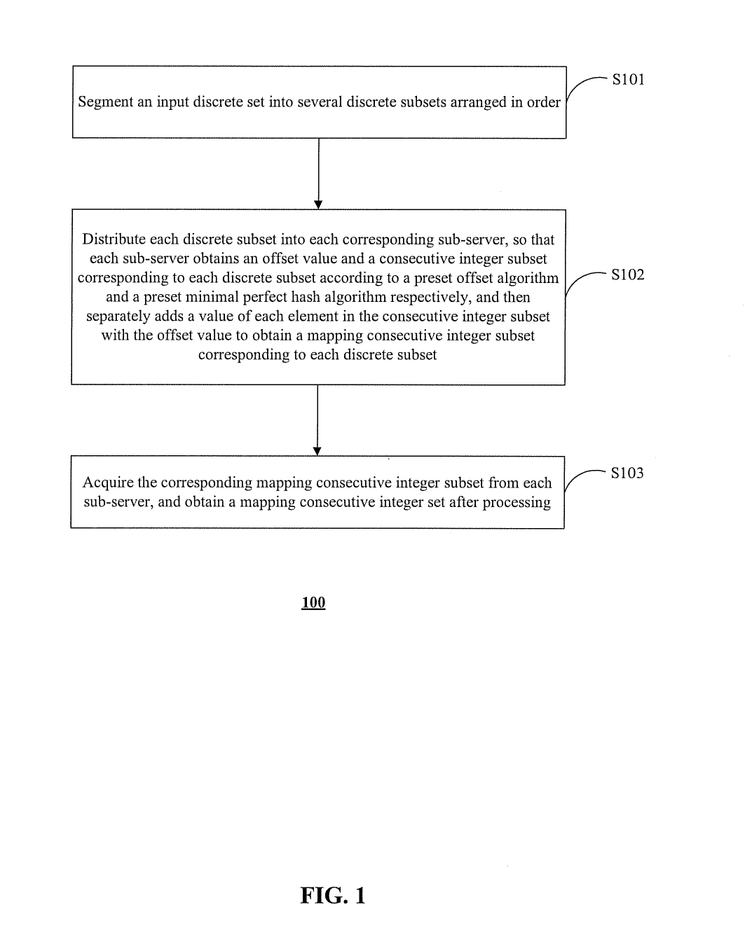

FIG. 1 is a schematic flowchart of a mapping method 100 according to embodiments of the present application. Method 100 can be applied to a primary server in a cluster system, and the cluster system further includes sub-servers. Method 100 can include steps S101-S103.

In step S101, an input discrete set can be segmented into several discrete subsets in order.

The segmentation can further include: a) obtaining a hash value of each element in the discrete set through mapping according to a preset hash function; b) performing a modulo operation on each hash value with respect to a preset positive integer, to obtain a mod value corresponding to the hash value of each element; and c) classifying elements having equal mod values into the same discrete subset to form a number of the discrete subsets, wherein the number is a preset positive integer.

In some embodiments, a large prime number can be selected as the preset positive integer.

It is appreciated that the foregoing set segmentation method is merely exemplary, and other manners may also be selected on this basis, so that the present application is applicable to more application fields. All these improvements belong to the protection scope of the present application.

In step S102, the discrete subset can be distributed into each sub-server respectively. Each sub-server obtains an offset value and a consecutive integer subset corresponding to each discrete subset according to a preset offset algorithm and a preset minimal perfect hash algorithm, respectively. And the sub-server can add a value of each element in the consecutive integer subset with the offset value to obtain a mapping consecutive integer subset corresponding to each discrete subset.

In some embodiments, multiple discrete subsets can be distributed by using multiple sub-servers to concurrently process the discrete subsets.

In step S103, the corresponding mapping consecutive integer subset can be acquired from each sub-server.

The corresponding mapping consecutive integer subset can be further processed to obtain a mapping consecutive integer set. For example, a union of all the mapping consecutive integer subsets can be determined, and all elements in the union can be ranked by magnitude to obtain the mapping consecutive integer set.

The present application also provides a mapping method applied to each sub-server in a cluster system, and the cluster system further includes a primary server.

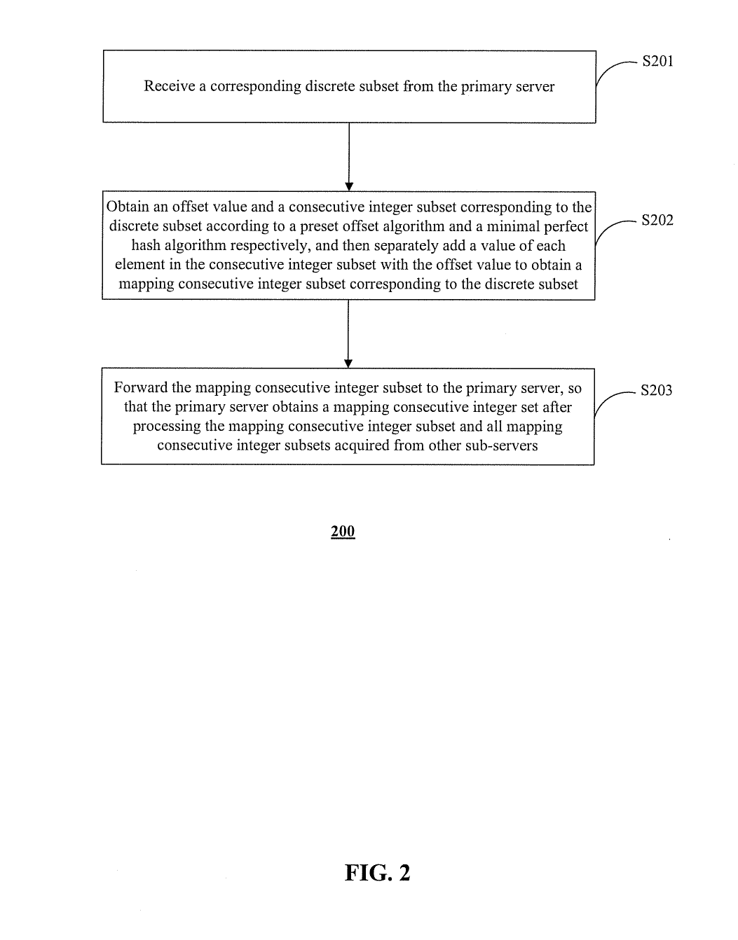

FIG. 2 shows a schematic flowchart of a mapping method 200 according to embodiments of the present application. Method 200 can include steps S201-S203.

In step S201, a discrete subset can be received from the primary server.

In some embodiments of the present application, after the primary server segments an input discrete set, each sub-server can receive a discrete subset respectively, thus achieving the objective of processing the discrete subsets concurrently.

In step S202, an offset value and a consecutive integer subset corresponding to the discrete subset can be obtained according to a preset offset algorithm and a minimal perfect hash algorithm respectively, and then a value of each element in the consecutive integer subset can be added with the offset value to obtain a mapping consecutive integer subset corresponding to the discrete subset.

In some embodiments of the present application, elements in each consecutive integer subset can be added with a corresponding offset separately. For example, discrete subset 1, discrete subset 2, and discrete subset 3 correspond to consecutive integer subset 1 {1,2,3,4}, consecutive integer subset 2 {1,2,3,4}, and consecutive integer subset 3 {1,2,3,4} respectively. If the primary server merges the consecutive integer subset 1, the consecutive integer subset 2, and the consecutive integer subset 3, a mapping consecutive integer set can be obtained as {1,2,3,4, 1,2,3,4, 1,2,3,4}, which cannot be realized. Therefore, the present application introduces a concept of an offset. For example, an offset of the discrete subset 1 is 0, an offset of the discrete subset 2 is 4, and an offset of the discrete subset 3 is 8. A corresponding mapping consecutive integer subset can be obtained after elements in each consecutive integer subset being added with the corresponding offsets separately. Thus, mapping consecutive integer subset 1 is {1,2,3,4}, mapping consecutive integer subset 2 is {5,6,7,8}, and mapping consecutive integer subset 3 is {9,10,11,12}. If the primary server merges mapping consecutive integer subset 1, mapping consecutive integer subset 2, and mapping consecutive integer subset 3, an obtained mapping consecutive integer set is {1,2,3,4,5,6,7,8,9,10,11,12}, thus achieving such a technical effect that a mapping result is a consecutive integer set.

Therefore, method 200 can further include the following steps for determining an offset value: a) determining whether the discrete subset is ranked in a first place among all discrete subsets; b) if the discrete subset is ranked in the first place, setting the offset value corresponding to the discrete subset to 0; and c) if the discrete subset is not ranked in the first place, setting the offset value corresponding to the discrete subset to a total number of elements in all discrete subsets ranked in front of the discrete subset.

It is appreciated that the above steps for determining an offset value can obtain a consecutive integer set after merging the mapping consecutive integer subsets.

In addition, a consecutive integer subset corresponding to the discrete subset can be obtained by using a minimal perfect hash algorithm. The number of elements in the discrete subset is the same as the number of elements in the consecutive integer subset. Meanwhile, the elements in the discrete subset correspond to the elements in the consecutive integer subset, respectively. For example, if the discrete subset includes 5 discrete elements, a consecutive integer subset including 5 consecutive integers (e.g., {0,1,2,3,4}) can be formed by using the minimal perfect hash algorithm. Then, the elements in the consecutive integer subset can be added with the corresponding offset to obtain a mapping consecutive integer subset corresponding to the discrete subset.

In some embodiments of the present application, the minimal perfect hash algorithm can further include steps a)-c):

In step a), hash functions having numbers can be constructed. A number of the hash functions can correspond to the number of elements in the discrete subset, where reference numbers of the hash functions can form a numeric sequence of consecutive positive integers starting from 0.

For example, if discrete subset Si includes four elements (e.g., x1, x2, x3 and x4), four hash functions (e.g., {h0, h1, h2, h4}) can be constructed.

In step b), the reference number of the hash function corresponding to each element can be determined according to a reference number assignment strategy, and the hash value corresponding to each element can be obtained separately.

The reference number is determined based on the following steps: 1) determining the number of all hash values corresponding to the discrete subset according to all mapping results of the elements based on the hash functions; 2) constructing an acyclic hypergraph by using the number of the elements as an edge quantity and the number of the hash values as a node quantity; 3) traversing each edge of the acyclic hypergraph to obtain a determination result corresponding to each node according to a node determination formula, to form an array based on the determination results; and 4) determining the number of the hash function corresponding to each element based on the array and a number determination formula.

For example, the step of determining the number of the hash function corresponding to each element based on the array and a number determination formula can further includes the following steps: determining a number value corresponding to the element according to the array and the preset number determination formula; determining whether the number value has been occupied; and if the number value has not been occupied, setting the number value as the number of the hash function corresponding to the element.

In step c), the hash values can be ranked to obtain the consecutive integer subset corresponding to the discrete subset.

In some embodiments, to rank the hash values, method 200 can further include: determining, according to a reference number of a hash function corresponding to the hash value, a number of all reference numbers that have been assigned before assignment of the reference number, an integer corresponding to the hash value being a value of the number; and obtaining the consecutive integer subset corresponding to the discrete subset based on the integers corresponding to the hash values.

In step S203, the primary server can acquire the mapping consecutive integer subsets from sub-servers, so that the primary server obtains a mapping consecutive integer set based on the mapping consecutive integer subsets.

Therefore, during continuous numeralization for a super-large-scale discrete set, the discrete set can be segmented and processed concurrently by using multiple servers in a cluster system. Moreover, a minimal perfect hash algorithm and a method for optimizing an offset mapping algorithm are designed. As such, the input discrete set can be linearly scaled correspondingly, and information of the original discrete set does not need to be saved in a generated mapping relationship, which significantly reduces memory occupation, and at the same time, improves mapping conversion efficiency and a learning effect of a machine learning algorithm and saves many hardware resources.

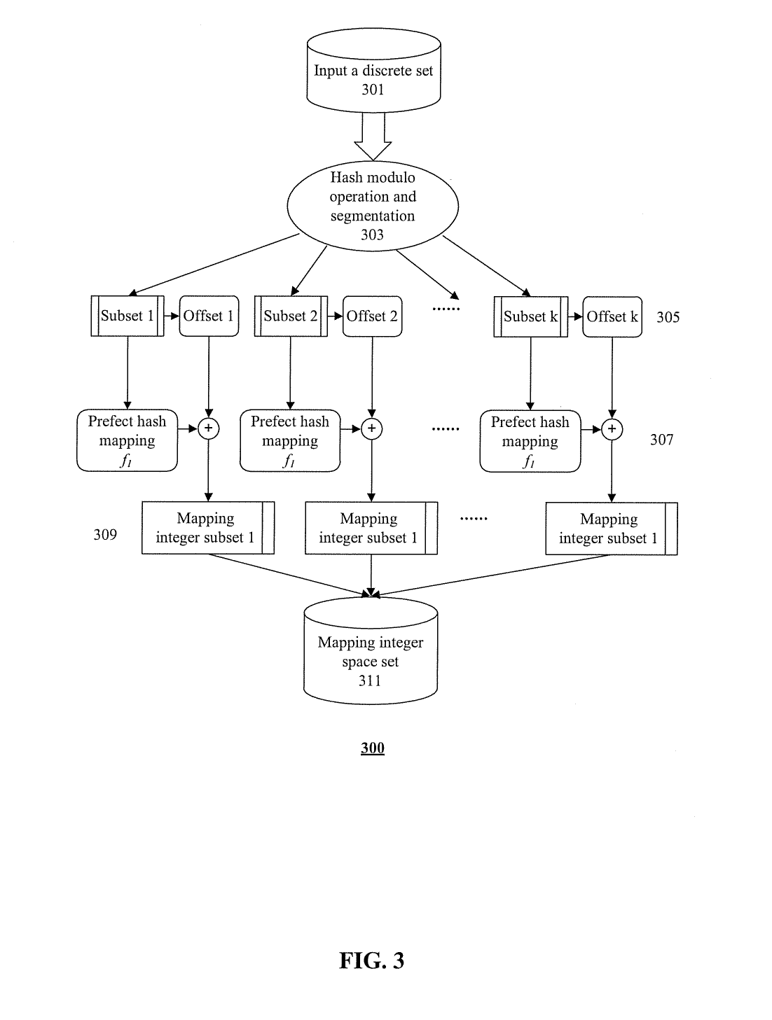

To further illustrate the technical idea of the present application, the technical solution of the present application is described now with reference to FIG. 3.

In some embodiments, a mapping method 300 is provided. Method 300 can include steps 301-309.

In step 301, an input discrete set can be received. A hash function h can be selected, and a hash value of each element in the discrete set can be obtained through mapping based on the hash function.

In step 303, a modulo operation can be performed on each hash value with respect to a positive integer k to obtain a mod value corresponding to the hash value of each element, and elements having equal mod values can be classified into the same discrete subset, such that k discrete subsets are obtained through segmentation.

In some embodiments, the i^{th} discrete subset Sᵢ (1≤i≤k) in step 302 can be expressed as:

Sᵢ={x,h(x)mod k=i},

wherein x is an element in the discrete subset, h(x) is a hash value corresponding to the element x, and i is in a range of [1, k].

No element repeats in each discrete subset obtained through segmentation in step 302, and the discrete subsets are of a substantially equal scale. Then, each discrete subset is distributed to each corresponding sub-server in the cluster system, and each sub-server can process the respective corresponding discrete subset concurrently. In other words, in step 302, all elements in the discrete set, of which mod values are i after the modulo operation based on the hash values, are classified into the discrete subset Sᵢ.

In step 305, each sub-server can concurrently determine an offset value of each discrete subset based on the respective corresponding discrete subset. And recursion of the offset is defined as follows:

$$\{ \begin{matrix}{Offset}_{1} = 0 \\ {Offset}_{i} = {\sum }_{j = 1}^{i - 1} \vert {S}_{j} \vert , 1 < i \leq k\end{matrix} .$$

Offsetᵢ is an offset value corresponding to the i^{th} discrete subset, and |Sⱼ|(1≤j≤i−1) is the number of elements in the j^{th} discrete subset.

For example, an offset value Offset₁ of the first discrete subset is 0. Starting from the second discrete subset, an offset value corresponding to each discrete subset is the total number of elements in all discrete subsets ranked in front of the discrete subset.

In step 307, each sub-server processes the respective corresponding discrete subset concurrently, and for each discrete subset Si, generates a mapping relationship fi based on a Minimal Perfect Hash algorithm as below:

fᵢ:Sᵢ→Nᵢ,|Sᵢ|=nᵢ,Nᵢ={0,1,K,nᵢ−1},

wherein the mapping relationship fᵢ maps the discrete subset Sᵢ to a consecutive integer space set Nᵢ, Nᵢ is in a range of [0, nᵢ−], and |Sᵢ|=nᵢ represents that the number of elements in the ith discrete subset is nᵢ.

In some embodiments, step 307 may further include a mapping step, an assignment step, and a ranking step.

In the mapping step, nᵢ hash functions {h0, h1, . . . hnⱼ₋₁} can be randomly selected and constructed from a set of hash functions H according to the number nᵢ of elements in the discrete subset Sᵢ, the number of the hash functions constructed is equal to the number of elements in the discrete subset. A known hash function h′ is selected, and nᵢ hash values h0′, h1′, . . . , hnᵢ₋₁′ are generated for an arbitrary element x in the discrete subset Sᵢ respectively. Thus:

h₀=h₀′ mod η

h₁=h₁′ mod η+η

h₂=h₂′ mod η+2η

K

Thus, nᵢ hash functions about the element x can be obtained. All the elements in the discrete subset can be processed according to the foregoing formulas. η is a preset parameter. A value range of the selected hash functions is [0,η×ni). In other words, for nᵢ elements in the discrete subset Sᵢ, the set of hash functions {h0, h1, . . . , hnᵢ₋₁} outputs η×nᵢ values.

An acyclic nᵢ-partite hypergraph can be constructed. An edge quantity of each independent subset in the hypergraph is the same as the number nᵢ of the elements in Si. Each node in the hypergraph corresponds to an output value obtained by the generated nᵢ hash functions on an element in the subset, and the output value is in a range of [0, m−1]. There are m such nodes, where m=η·ηᵢ.

In the assignment step, in the acyclic nᵢ-partite hypergraph, the arbitrary element x in the discrete subset Sᵢ corresponds to nᵢ nodes from the output values of the nᵢ hash functions. The nᵢ nodes can be denoted as V={v0, v1, . . . , vnᵢ₋₁}. Each node includes an integer value corresponding to the node.

To assign an integer value to an arbitrary element x in the discrete subset Sᵢ, each edge of the acyclic hypergraph can be traversed. And on each edge, a first unassigned node u can be found as:

g[u]=(j−Σ_{νεeΛ}_{_{Visited[ν]=true}}g[ν])mod 3.

A calculation result corresponding to each node can be obtained according to the above formula, to form an array g={g₀, g₁, . . . , gₘ₋₁}, wherein 0≤gᵢ≤nᵢ. The array g={g₀, g₁, . . . , gₘ₋₁} is applicable to the process of an arbitrary element x in the discrete subset Sᵢ.

Then, a number value corresponding to the element can be determined according to the array g={g₀, g₁, . . . , gₘ₋₁} and a reference number determination formula. Thus, an integer value on a unique node to which an arbitrary element x in the discrete subset Si corresponds can be determined. The reference number determination formula can be as follows:

i=(gₕ₀₍ₓ₎+gₕ₁₍ₓ₎+L+gₕ₍ₙᵢ₋₁₎₍ₓ₎)mod nᵢ

Then, it is determined whether the reference number value i has been used. If the reference number value has not been used yet, the reference number value can be assigned as the reference number of the hash function corresponding to the element x. That is, the calculation result corresponding to the hash function hi is the integer value corresponding to the element x, and a value range of the integer value is [0, m). If the reference number value has been used, a next reference number i+1 can be found, and it can be further determined whether the reference number value i+1 has been used. If the next reference number value i+1 has not been used, the next number value i+1 can be the number of the hash function corresponding to the element. That is, the calculation result corresponding to the hash function hi+1 can be the integer value corresponding to the element x, and a value range of the integer value is [0,).

In the ranking step, an integer value has been assigned in the Assignment step to each element in the discrete subset, with the value range of the integer value being [0, m). To obtain a minimal hash function, the value range of the integer value can be further narrowed from [0, m) to [0, nᵢ−1].

A number list can be generated. The number list is a one-dimensional array having a length of nᵢ. The value corresponding to each subscript represents the number of integers that have been used by the assignment step before assignment of the subscript, as below:

$$\{ \begin{matrix}rank [ 0 ] = 0 \\ rank [ i ] = rank [ i - 1 ] + assigned [ i - 1 ] , 1 \leq i < {n}_{i}\end{matrix} ,$$

wherein assigned[i] represents whether the i^{th} number has been used in the assignment step. After the ranking step, the elements in the discrete subset are one-to-one mapped to a continuous integer space set. A value range of the integer space set is [0, nᵢ−1]. The minimal hash function can be expressed by using the following formula:

mphᵢ(x)=rank[hᵢ(x)]

where mphᵢ(x) is an output value of a minimal hash function corresponding to an arbitrary element x in the i^{th} discrete subset Sᵢ, and rank[hᵢ(x)] is a processing procedure of the ranking step.

In step 309, the sub-servers can process, based on the continuous integer space subset obtained in step 307, to separately add the hash value of each element in the integer space set of each sub-server with the offset value determined in 305 to obtain a final mapping consecutive integer subset.

In some embodiments, the final mapping consecutive integer subset can be expressed as:

fᵢ(x)=mphᵢ(x)+Offsetᵢ

where mphᵢ(x) is an output value of a minimal hash function corresponding to an arbitrary element x in the i^{th} discrete subset Sᵢ, and Offsetᵢ is an offset value corresponding to the ith discrete subset.

In step 311, the mapping consecutive integer subsets generated in the sub-servers can be summarized into one set to form a mapping consecutive integer set.

In embodiments of the disclosure, during continuous numeralization for a super-large-scale discrete set, the discrete set can be segmented and then processed concurrently by using multiple servers in a cluster system. Moreover, a minimal hash algorithm and a method for optimizing an offset mapping algorithm are designed. As such, the input discrete set can be linearly scaled correspondingly, and information of the original discrete set does not need to be saved in a generated mapping relationship, which significantly reduces memory occupation, and at the same time, improves mapping conversion efficiency and a learning effect of a machine learning algorithm and saves many hardware resources.

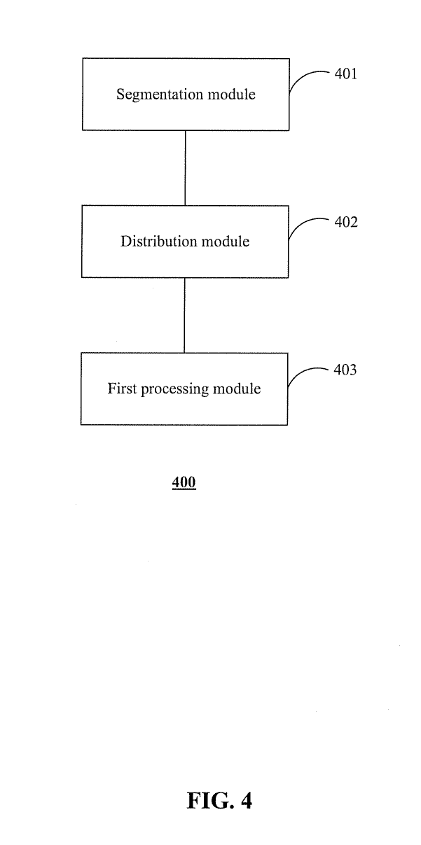

In order to achieve the foregoing technical objective, the present application further provides a server 400. Server 400 can be a primary server applied in a discrete processing cluster system. The cluster system further includes sub-servers. As shown in FIG. 4, server 400 can include a segmentation module 401, a distribution module 402, and a first processing module 403.

Segmentation module 401 can configured to segment a received discrete set into several discrete subsets arranged in order.

Distribution module 402 can be configured to distribute each discrete subset into each corresponding sub-server, so that each sub-server obtains an offset value and a consecutive integer subset corresponding to each discrete subset according to a preset offset algorithm and a preset minimal perfect hash algorithm respectively, and then separately adds a value of each element in the consecutive integer subset with the offset value to obtain a mapping consecutive integer subset corresponding to each discrete subset; and

First processing module 403 can be configured to acquire the corresponding mapping consecutive integer subset from each sub-server, and obtain a mapping consecutive integer set after processing.

In some embodiments, the segmentation module can be further configured to: obtain a hash value of each element in the discrete set through mapping according to a preset hash function; perform a modulo operation on each hash value with respect to a preset positive integer to obtain a mod value corresponding to the hash value of each element; and classify elements having equal mod values into the same discrete subset, to form the discrete subsets of which the number is a preset positive integer.

In some embodiments, the first processing module can be further configured to: calculate a union of all the mapping consecutive integer subsets; and rank all elements in the union by magnitude to obtain the mapping consecutive integer set.

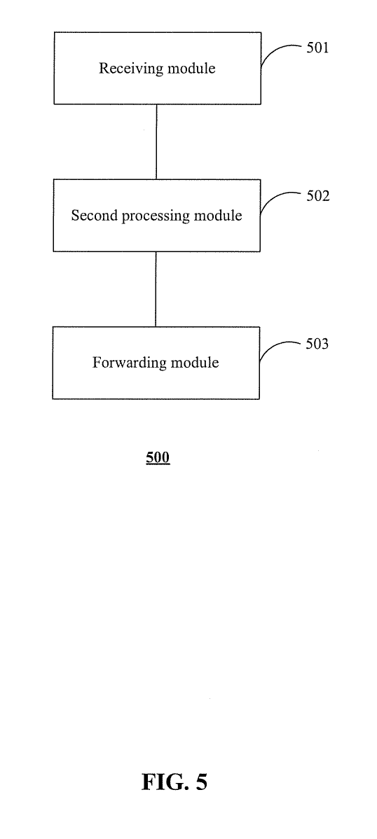

To achieve the foregoing technical objective, the present application further provides a server 500. Server 500 can be a sub-server applied in a cluster system. The cluster system further includes a primary server. As shown in FIG. 5, server 500 includes a receiving module 501, a second processing module 502, and a forwarding module 503.

Receiving module 501 can be configured to receive a corresponding discrete subset from the primary server.

Second processing module 502 can be configured to obtain an offset value and a consecutive integer subset corresponding to the discrete subset according to a preset offset algorithm and a minimal perfect hash algorithm respectively, and then separately add a value of each element in the consecutive integer subset with the offset value to obtain a mapping consecutive integer subset corresponding to the discrete subset.

Forwarding module 503 can be configured to forward the mapping consecutive integer subset to the primary server, so that the primary server obtains a mapping consecutive integer set after processing the mapping consecutive integer subset and all mapping consecutive integer subsets acquired from other sub-servers.

In some embodiments, the second processing module can be further configured to determine whether the discrete subset is ranked in the first place among all discrete subsets; if the discrete subset is ranked in the first place among all discrete subsets, set the offset value corresponding to the discrete subset to 0; and if the discrete subset is not ranked in the first place among all discrete subsets, set the offset value corresponding to the discrete subset to the total number of elements in all discrete subsets ranked in front of the discrete subset.

In some embodiments, the second processing module can be further configured to: construct hash functions having numbers, the number of the hash functions corresponding to the number of elements in the discrete subset, where the numbers of the hash functions form a numeric sequence of consecutive positive integers starting from 0; determine the number of the hash function corresponding to each element according to a preset number assignment strategy, and separately obtain the hash value corresponding to each element; and sort the hash values to obtain the consecutive integer subset corresponding to the discrete subset.

In some embodiments, the second processing module can be further configured to: determine the number of all hash values corresponding to the discrete subset according to all mapping results of the elements based on the hash functions; construct an acyclic hypergraph by using the number of the elements as an edge quantity and the number of the hash values as a node quantity; traverse each edge of the acyclic hypergraph, and obtain a calculation result corresponding to each node according to a preset node calculation formula, to form an array based on the calculation results; and deter line the number of the hash function corresponding to each element based on the array and a preset number calculation formula.

In some embodiments, the second processing module can be further configured to: calculate a number value corresponding to the element according to the array and the preset number calculation formula; determine whether the number value has been occupied; and if the number value has not been occupied, set the number value as the number of the hash function corresponding to the element.

In some embodiments, the second processing module can be further configured to determine, according to the number of the hash function corresponding to the hash value, the number of all numbers that have been assigned before assignment of the number, an integer corresponding to the hash value being a value of the number; and summarize the integers corresponding to the hash values, to obtain the consecutive integer subset corresponding to the discrete subset.

According to the description of the foregoing implementations, it is appreciated that the present application can be implemented by hardware or implemented by software plus a necessary universal hardware platform. Based on such understanding, the technical solution of the present application can be embodied in the form of a software product. The software product can be stored in a non-volatile storage medium (such as a CD-ROM, a USB flash drive, or a mobile hard disk drive), and includes several instructions for instructing a computer device (which can be a personal computer, a server, a network device, or the like) to execute the methods in various implementation scenarios of the present application.

It is also appreciated that the accompanying drawings are merely schematic diagrams of embodiments. Modules or processes in the accompanying drawings are not necessarily mandatory to the implementation of the present application.

It is further appreciated that modules in an apparatus in an implementation scenario can be distributed in the apparatus in the implementation scenario according to the description of the implementation scenario, and can also be located in one or more apparatuses different from the apparatus in the current implementation scenario. The modules in the implementation scenario can be combined into one module, and can also be further divided into multiple sub-modules.

The sequence numbers in the present application are merely for the convenience of description, and do not imply the preference among implementation scenarios.

The above disclosed are merely some embodiments of the present application. However, the present application is not limited to these embodiments. All variations that can be conceived of by those skilled in the art should fall in the protection scope of the present application.

1. A mapping method for a primary server in a cluster system, wherein the cluster system further includes a plurality of sub-servers, and the method comprises:
segmenting an input discrete set into a plurality of discrete subsets that includes a first discrete subset and a second discrete subset;
distributing the plurality of discrete subsets into the sub-servers, wherein
a first sub-server of the plurality of sub-servers obtains a first offset value and a first consecutive integer subset corresponding to a first discrete subset distributed to the first sub-server and adds values of elements in the first consecutive integer subset with the first offset value to obtain a first mapping consecutive integer subset corresponding to the first discrete subset, and
a second sub-server of the plurality of sub-servers obtains a second offset value and a second consecutive integer subset corresponding to the second discrete subset distributed to the second sub-server and adds values of elements in the second consecutive integer subset with the second offset value to obtain a second mapping consecutive integer subset corresponding to second discrete subset;
acquiring the first and second mapping consecutive integer subsets from the first and second sub-servers; and
obtaining a mapping consecutive integer set based on the first and second mapping consecutive integer subsets.

2. The method according to claim 1, wherein segmenting the input discrete set into the plurality of discrete subsets further comprises:
obtaining hash values for elements in the discrete set through mapping according to a hash function;
performing a modulo operation on the hash values with respect to a positive integer, to obtain a mod value corresponding to the hash values; and
classifying elements having equal mod values into a discrete subset to form at least one discrete subset of the plurality of discrete subsets.

3. The method according to claim 1, wherein obtaining the mapping consecutive integer set based on the first and second mapping consecutive integer subsets further comprises:
determining a union of the first and second mapping consecutive integer subsets; and
ranking elements in the union by magnitude to obtain the mapping consecutive integer set.

4. A mapping method for a sub-server in a cluster system, wherein the cluster system further includes a primary server, and the method comprises:
receiving a discrete subset from the primary server;
obtaining an offset value and a consecutive integer subset corresponding to the discrete subset;
adding values of the elements in the consecutive integer subset with the offset value to obtain a mapping consecutive integer subset corresponding to the discrete subset; and
transmitting the mapping consecutive integer subset to the primary server for generating a mapping consecutive integer set based on the mapping consecutive integer subset.

5. The method according to claim 4, wherein obtaining the offset value and the consecutive integer subset corresponding to the discrete subset further comprises:
determining whether the discrete subset is ranked in a first place among discrete subsets;
in response to the discrete subset being ranked in a first place among discrete subsets, setting the offset value corresponding to the discrete subset to 0; and
in response to the discrete subset being not ranked in a first place among discrete subsets, setting the offset value corresponding to the discrete subset to a total number of elements in the discrete subsets ranked in front of the discrete subset.

6. The method according to claim 4, wherein obtaining the offset value and the consecutive integer subset corresponding to the discrete subset further comprises:
constructing hash functions having reference numbers, a number of the hash functions corresponding to the total number of elements in the discrete subset, wherein the reference numbers of the hash functions form a numeric sequence of consecutive integers starting from 0;
determining the reference numbers of the hash functions corresponding to the elements, and determining the hash values corresponding to the elements; and
sorting the hash values to obtain the consecutive integer subset corresponding to the discrete subset.

7. The method according to claim 6, wherein determining the reference numbers of the hash function corresponding to the elements further comprises:
determining a number of hash values corresponding to the discrete subsets according to mapping results of the elements based on the hash functions;
constructing an acyclic hypergraph by using a number of the elements as an edge quantity and the number of the hash values as a node quantity;
traversing edges of the acyclic hypergraph to generate an array; and
determining the reference numbers of the hash functions corresponding to elements based on the array and a reference number determination formula.

8. The method according to claim 7, wherein determining the numbers of the hash functions corresponding to the element based on the array and the reference number determination formula further comprises:
determining a reference number value corresponding to the element according to the array and the reference number determination formula;
determining whether the reference number value has been occupied; and
in response to the reference number value having not been occupied, setting the reference number value as the reference number of the hash function corresponding to the element.

9. The method according to claim 6, wherein sorting the hash values to obtain the consecutive integer subset corresponding to the discrete subset further comprises:
determining, according to the reference number of the hash function, a number of reference numbers that have been assigned before assignment of the reference number, an integer corresponding to the hash value being a value of the number; and
summarizing integers corresponding to the hash values to obtain the consecutive integer subset corresponding to the discrete subset.

10-18. (canceled)

19. A non-transitory computer readable medium that stores a set of instructions that is executable by at least one processor of a primary server in a cluster system to cause the primary server to perform a mapping method, wherein the cluster system further includes sub-servers, and the method comprises:
segmenting an input discrete set into a plurality of discrete subsets that includes a first discrete subset and a second discrete subset;
distributing the plurality of discrete subsets into the sub-servers, wherein
a first sub-server of the plurality of sub-servers obtains a first offset value and a first consecutive integer subset corresponding to a first discrete subset distributed to the first sub-server and adds values of elements in the first consecutive integer subset with the first offset value to obtain a first mapping consecutive integer subset corresponding to the first discrete subset, and
a second sub-server of the plurality of sub-servers obtains a second offset value and a second consecutive integer subset corresponding to the second discrete subset distributed to the second sub-server and adds values of elements in the second consecutive integer subset with the second offset value to obtain a second mapping consecutive integer subset corresponding to second discrete subset;
acquiring the first and second mapping consecutive integer subsets from the first and second sub-servers; and
obtaining a mapping consecutive integer set based on the first and second mapping consecutive integer subsets.

20. The non-transitory computer readable medium of claim 19, wherein segmenting the input discrete set into the plurality of discrete subsets further comprises:
obtaining hash values for elements in the discrete set through mapping according to a hash function;
performing a modulo operation on the hash values with respect to a positive integer, to obtain a mod value corresponding to the hash values; and
classifying elements having equal mod values into a discrete subset to form at least one discrete subset of the plurality of discrete subsets.

21. The non-transitory computer readable medium according to claim 19, wherein obtaining the mapping consecutive integer set based on the mapping consecutive integer subsets further comprises:
determining a union of the first and second mapping consecutive integer subsets; and
ranking elements in the union by magnitude to obtain the mapping consecutive integer set.

22. A non-transitory computer readable medium that stores a set of instructions that is executable by at least one processor of a sub-server in a cluster system to cause the sub-server to perform a mapping method, wherein the cluster system further includes a primary server, and the method comprises:
receiving a discrete subset from the primary server;
obtaining an offset value and a consecutive integer subset corresponding to the discrete subset;
adding values of the elements in the consecutive integer subset with the offset value to obtain a mapping consecutive integer subset corresponding to the discrete subset; and
transmitting the mapping consecutive integer subset to the primary server for generating a mapping consecutive integer set based on the mapping consecutive integer subset.

23. The non-transitory computer readable medium according to claim 22, wherein obtaining the offset value and the consecutive integer subset corresponding to the discrete subset further comprises:
determining whether the discrete subset is ranked in a first place among discrete subsets;
in response to the discrete subset being ranked in a first place among discrete subsets, setting the offset value corresponding to the discrete subset to 0; and
in response to the discrete subset being not ranked in a first place among discrete subsets, setting the offset value corresponding to the discrete subset to a total number of elements in the discrete subsets ranked in front of the discrete subset.

24. The non-transitory computer readable medium according to claim 22, wherein obtaining the offset value and the consecutive integer subset corresponding to the discrete subset further comprises:
constructing hash functions having reference numbers, a number of the hash functions corresponding to the total number of elements in the discrete subset, wherein the reference numbers of the hash functions form a numeric sequence of consecutive integers starting from 0;
determining the reference numbers of the hash functions corresponding to the elements, and determining the hash values corresponding to the elements; and
sorting the hash values to obtain the consecutive integer subset corresponding to the discrete subset.

25. The non-transitory computer readable medium according to claim 24, wherein determining the reference number of the hash function corresponding to each element further comprises:
determining a number of hash values corresponding to the discrete subsets according to mapping results of the elements based on the hash functions;
constructing an acyclic hypergraph by using a number of the elements as an edge quantity and the number of the hash values as a node quantity;
traversing edges of the acyclic hypergraph to generate an array; and
determining the reference numbers of the hash functions corresponding to elements based on the array and a reference number determination formula.

26. The non-transitory computer readable medium according to claim 25, wherein determining the number of the hash function corresponding to each element based on the array and a reference number determination formula further comprises:
determining a reference number value corresponding to the element according to the array and the reference number determination formula;
determining whether the reference number value has been occupied; and
in response to the reference number value having not been occupied, setting the reference number value as the reference number of the hash function corresponding to the element.

27. The non-transitory computer readable medium according to claim 24, wherein sorting the hash values to obtain the consecutive integer subset corresponding to the discrete subset further comprises:
determining, according to the reference number of the hash function, a number of reference numbers that have been assigned before assignment of the reference number, an integer corresponding to the hash value being a value of the number; and
summarizing integers corresponding to the hash values to obtain the consecutive integer subset corresponding to the discrete subset.
